(19) United States
(12) Patent Application Publication
(10) Pub. No.: US 2010/0270493 A1
(43) Pub. Date: Oct. 28, 2010

(54) HOT TEST FLUID CONTAINING VAPOR PHASE INHIBITION PROTECTION FOR FERROUS AS WELL AS ALUMINUM ALLOYS

(75) Inventors: Jurgen P. De Kimpe, Gent (BE); Serge S. Lievens, Merelbeke (BE)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/428,270

(22) Filed: Apr. 22, 2009

(51) Int. Cl. C09K 5/00; C23F 11/00

(52) U.S. Cl. 252/76; 252/389.3

(57) ABSTRACT

The technology of this invention relates to a solution that provides protection against forms of corrosion. Such solutions are intended for use in applications where cooling system parts are hot tested or the engine is run-in prior to it being stored and/or assembled in the final vehicle or engine configuration. The invention covers a concentrate as well as a dilute solution made from the concentrate. The synergistic combination of inorganic ammonium derivatives with monocarboxylic or dicarboxylic acids has proven to dramatically increase the protection time, thus enabling storage for a longer period when the engine parts are shipped or stored prior to assembling. When silicate is added to the above formulation, excellent protection from liquid and vapor corrosion is provided on ferrous liner alloys as well as on aluminum alloys. Aluminum alloys are used in engine heads. The use of inorganic ammonium derivatives in combination with monocarboxylate or dicarboxylic acids and silicate has proven to dramatically enhance the protection time and enable the storage for a longer period when different engine parts are shipped or stored prior to assembling. The use of the described invention shows a pre-conditioning of the metal surface and provides protection even if afterwards the liquid is almost completely removed. Other traditional or organic inhibitors like triazole, nitrate, nitrite, borate, molybdate, phosphate can optionally be added. A freezing point depressant can be added as well, providing, in addition to freezing protection, an increased vapor phase protection level.

### TECHNICAL FIELD

The technology of this invention relates to a solution that provides protection against forms of corrosion.

### BACKGROUND

Combustion engines, such as gasoline, diesel or gas engines, as well as the more modern fuel cell systems are, following the production process going through a “running-in” phase prior to parts assembly. This running-in phase varies from several minutes to a few hours, depending on the type of engine and the operation it will face later on. Through the “running-in” phase, the functionality of the engine or the system is guaranteed. Today's running-in fluids can be very diverse as they range from pure water over coolant to oil emulsions. All of them show some sort of technical disadvantage. When building in the parts directly after the running-in phase, all mentioned ways of operation can be used. In many cases however, the engine builders centralize their production. Parts are shipped all over the world prior to being built into the final operating configuration. During this storage and transport time the parts can come in contact with corrosive conditions and require protection against the negative influences they face during storage and/or transport. For cost saving the running-in fluid is almost completely removed prior to the engine part going into storage and the engine is left behind in so called wet conditions.

This way of operation means that standard coolant technologies do not provide optimal protection. Most of the current technologies provide no sustained protection when not having direct contact with the surface they need to protect. Using a standard coolant formulation as hot test fluid is certainly viable in situations where the parts are directly built in after testing. In the modern economic situation however, this is less and less the case. Combined storage and transport time periods are observed from 3 to up to 9 months.

In modern combustion engines particularly, thermal loads set high requirements with regard to the materials used. Any form of corrosion, even minor forms, result in a potential risk factor and can lead to a reduction of the lifetime of the engine and correspondingly, safe vehicle operation. In addition, an increased number of different metallurgies and different alloys are used making the system more susceptible to corrosion certainly on those places where the different parts or alloys make direct or indirect contact with each other.

Most running-in fluids focus on the protection of ferrous alloys, since those alloys are more sensitive to general forms of corrosion. Engine blocks and also engine liners are some typical examples where ferrous corrosion protection is needed during transport or storage. In addition, the formed corrosion products are very visual and relatively easy to dissolve in the cooling system. Once the corrosion products are released from the corroded surface they can be transported and create other issues like blockages, galvanic corrosion or problems related to heat transfer. In engine construction, one can observe the trend towards lighter alloys like aluminum for the water pump or even the engine head. Since, in current engine design, multiple parts are pre-assembled together, the need for a running-in fluid that protects all metals and not solely ferrous alloys is a must.

On the other hand, oil emulsions do provide protection when the system is almost drained; however, they show some incompatibility issues when later on the coolant is added to the system. Although the soluble oil provides some residual corrosion protection, it will decrease the heat transfer in the system by forming a heat isolating although protective layer. As efficient heat removal is essential certainly in the more powerful engines that comply with the more modern environmental legislation, the running-in fluid should not negatively affect the heat transfer from the parts into the cooling system.

Coolants are used to remove heat from the engine. To give the engine optimal efficiency the excess of heat need to be removed as fast as possible without damaging or decreasing the operation of all cooling system parts. A lot of work and effort has been put towards the protection of the cooling system materials especially towards the protection against corrosion at high temperatures. Although from a corrosion standpoint high temperatures are indeed very critical also the low temperature domain is of high importance during engine operation. At low temperature the solubility and low temperature pumpability not the corrosion protection is of major importance.

Ideally the coolant remains transparent and free of insolubles. Haziness, precipitation or in extremes gel formation are considered detrimental for the performance of an engine coolant. Problems resulting from instability can be seen in water pump seals, engine head seals, hoses or any other parts where softer materials are in use. Gel formation on the other hand will have a negative impact on the viscosity and results in a negative change of the heat transfer characteristics of the fluid, being the main requirement of a coolant fluid. As the risk for coolant instability is maximal at low temperatures, most problems occur under cold start conditions.

### SUMMARY

The invention combines the positive characteristics from both coolants and oil emulsion. It combines the excellent compatibility with the coolant added later and does not negatively affect the heat transfer characteristics, as is the case when an oil emulsion is used. It also provides sustainable corrosion protection during the running-in period and during storage when most of the product has been drained. The present invention does not only protect parts built from ferrous alloys but also provides protection for parts made up of more than one metal, as well as pure aluminum parts used in the cooling system and exposed to the aggressive vapor storage conditions. Best results are observed when the part is sealed or air flow is not completely free. This allows the additives to come to equilibrium and condition the atmosphere so corrosion protection is guaranteed during storage or transport.

One embodiment of the invention may be a concentrate used to prepare a running-in or hot test fluid. The concentrate may be diluted, preferably with water to provide a solution, a second embodiment. Alternatively also a freezing protection base fluid like an alcohol or short chain organic acid can be added for those situations where freezing protection would be needed during storage or transport.

The addition of a liquid with increased viscosity relative to water to provide freeze protection further improves the protection level during storage and or transport. As those freezing depressant fluids have a higher viscosity and are considered to be slippery, they are not preferred unless freeze protection is really needed. It has been observed that the positive effect of those base fluids is no longer a fundamental requirement when using the invention. A liquid alcohol or organic salt freezing point depressant can also be added to provide freezing protection. The freezing point depressant contains polyalcohols such as ethylene glycol, di-ethylene glycol, propylene glycol, di-propylene glycol, glycerin and glycol monoethers such as the methyl, ethyl, propyl and butyl ethers of ethylene glycol, di-ethylene glycol, propylene glycol and di-propylene glycol. Ethylene and propylene glycol are particularly preferred as the freezing point depressant component. Non-limiting examples of organic acid salt freezing point depressant contains carboxylates like formiate, acetate, propionate, adipate or succinate or combinations thereof.

Alternatively additional coolant additives like nitrites, nitrates, phosphates, molybdates, anti-oxidants, thiazole derivatives, triazoles, polyacrylates, phosphonates and borates can be used to provide protection in the water phase.

### DETAILED DESCRIPTION

The stability effect of organic acids in synergistic combination with an inorganic ammonium salt and silicate, for the protection of multi-metal protection after hot testing or running-in phase appears to be novel. Many patents describe explicitly the use of freezing point depressants when trying to provide vapor phase protection after running-in cycle. The current invention provides sufficient protection in the liquid as well as in the vapor phase for ferrous alloys and aluminum alloys, even without the addition of a freezing point depressant. In case freezing point depressant is needed it can, of course, be added and an even more improved performance will be noticeable.

It has been observed that by combining carboxylic acids with inorganic ammonium compounds and silicate, corrosion protection is obtained for aluminum, commonly used in water pumps, heater cores and engine heads, and ferrous alloys commonly used in cylinder liners and engine blocks. This not only in the liquid phase but more importantly in the vapor phase.

### EXAMPLE 1 (COMPARATIVE EXAMPLE)

A running-in fluid was prepared comprising a major amount of water, 1.5 weight percent isononanoic acid, 0.95 weight percent benzoic acid, 0.1 weight percent triazole, 0.1 weight percent ammonium bicarbonate and brought to a pH of 8.9.

### EXAMPLE 2 (COMPARATIVE EXAMPLE)

A running-in fluid was prepared comprising a major amount of water, 1.5 weight percent isononanoic acid, 0.95 weight percent benzoic acid, 0.1 weight percent triazole, 0.17 weight percent ammonium bicarbonate and brought to a pH of 8.9.

### EXAMPLE 3 (COMPARATIVE EXAMPLE)

A running-in fluid was prepared comprising a major amount of water, 1.5 weight percent isononanoic acid, 0.95 weight percent benzoic acid, 0.1 weight percent triazole, 0.04 weight percent ammonium bicarbonate, 0.07 weight percent sodium metasilicate pentahydrate, 0.14 weight percent silicate stabilizer and brought to a pH of 8.9.

### EXAMPLE 4 (EXAMPLE OF INVENTION)

A running-in fluid was prepared comprising a major amount of water, 1.5 weight percent isononanoic acid, 0.95 weight percent benzoic acid, 0.1 weight percent triazole, 0.13 weight percent ammonium bicarbonate, 0.07 weight percent sodium metasilicate pentahydrate 0.14 weight percent silicate stabilizer and brought to a pH of 8.9.

Examples of optional freezing point depressants are poly alcohols, small chain organic acids and low molecular weight alcohols. These include but are not limited to ethylene glycol, propylene glycol, diethylene glycol, glycerin, salt of formic acid, salt of acetic acid, salt of propionic acid, salt of adipic acid and glycerol. To be used in cooling systems, they are mixed with water to ensure good heat transfer in addition to freezing protection. Those water based mixtures are however, corrosive under the operating conditions typically found in the targeted applications. Therefore the different metals and corresponding alloys present in the cooling system need to be sufficiently protected from the different corrosion processes like pitting, crevice corrosion, erosion or cavitation.

Examples of optional additional coolant are the typical coolant additives. These include but are not limited to silicates, nitrites, nitrates, phosphates, molybdates, anti-oxidants, thiazole derivatives, triazoles, polyacrylates, phosphonates and borates that can be used to provide protection in the water phase.

### Test Method

As we try to protect different metals, a selection of different metals was performed and a test bundle comprised of Copper, Cast iron 1 (engine block alloy), Cast iron 2 (cover alloy), Cast Iron 3 (liner alloy), and aluminum was used. Aluminum alloys as well as ferrous alloys were selected as the subject metals.

All pieces are handled in an identical way as in ASTM D-1384, (standard test method for corrosion test for engine coolants in glassware) and assembled as follows:
From left to right:
Teflon leg/Brass spacer/Teflon small ring/COPPER/Brass ring/Teflon small ring/CAST IRON 1/Steel Spacer/Steel spacer/CAST IRON 2/Steel Spacer/CAST IRON 3/Steel Spacer/Teflon small ring/ALUMINUM/Brass spacer/Teflon leg

The metal bundle is placed in a glass vial and filled with running-in fluid. The vial is put in the oven and a temperature cycle is performed:
1 hour at 130° C. (air temperature) +30 min at 100° C. (air temperature)

Cool down for 8 hours

Remove half of the liquid so the metal bundle remains half submerged

The glass vial container with metal specimens is put back in the oven to follow below temperature cycle

8 hours at 23° C. (air temp)

8 hours at 40° C. (air temperature)

8 hours at 0° C.

This cycle is repeated for 7 days

After the temperature cycle is completed the metals specimens are examined and weight losses determined.
Visual examination and amount of weight lost were the criteria employed below.

### Results

| | | | | Example 4 |
|---|---|---|---|---|
| | Example 1 | Example 2 | Example 3 | (Example of |
| | (Comparative) | (Comparative) | (Comparative) | invention) |
| Visual liquid | Severe | Severe | No discoloration | No discoloration |
| phase | blackening | blackening | | |
| Aluminum | | | | |
| alloy | | | | |
| Visual vapor | Severe | Severe | No discoloration | No discoloration |
| phase | blackening | blackening | | |
| Aluminum | | | | |
| alloy | | | | |
| Weight loss | 15 mg | 17 mg | 0 mg | 0 mg |
| aluminum | | | | |
| alloy | | | | |
| Visual liquid | Slightly stained | Slightly stained | Slightly stained | Slightly stained |
| phase | | | | |
| Ferrous alloy | | | | |
| Visual vapor | Slightly stained | Slightly stained | Severely | Slightly stained |
| phase | | | corroded | |
| Ferrous alloy | | | | |
| Weight loss | 5 mg | 2 mg | 41 mg | 1 mg |
| Ferrous alloy* | | | | |

*average of 3 different alloys

It is apparent from the data of the Table that corrosion protection was superior, in both the liquid phase and vapor phase, when using the solution of the invention as opposed to the solutions of the Comparative Examples. Although comparative example 3 was giving excellent protection for ferrous alloys it did not show the improved protection level towards parts that were build on aluminum alloys.

We claim:

1. A concentrate comprising at least one inorganic ammonium compound in synergistic combination with at least one carboxylic acid, and a silicate, which is suitable for dilution with a solvent which provides anti-corrosion properties.

2. The concentrate of claim 1, wherein the inorganic ammonium compound is selected from the group ammonium bicarbonate, ammonium biphosphate, ammonium molybdate, ammonium nitrate, ammonium sulfate, ammonium perchlorate, ammonium persulfate, and ammonium hydroxide.

3. The concentrate of claim 1, wherein the carboxylate acid is selected from the group monocarboxylic acids, dicarboxylic acid, aliphatic monocarboxylic acid, aliphatic dicarboxilic acid, branched carboxylic acid or aromatic unbranched and branched carboxylic acids.

4. The concentrate of claim 1, wherein the silicate is an inorganic alkali metal silicate.

5. A ready-to-use “running-in” fluid providing anti-corrosion properties in the “hot-test” or “running-in” phase of an engine, which comprises, in a minor amount, at least one inorganic ammonium compound in synergistic combination with at least one carboxylic acid and a silicate, and further comprising, in a major amount, a solvent.

6. The fluid of claim 5, wherein the inorganic ammonium compound is present in an amount below 5 wt %.

7. The fluid of claim 6, wherein the inorganic ammonium is present in an amount in the range from 0.05 to 2 wt %.

8. The fluid of claim 5, wherein carboxylic acid is present in an amount below 15 wt %.

9. The fluid of claim 8, wherein the carboxylic acid is present in an amount in the range between 0.01 and 5 wt %.

10. The fluid of claim 5, having a pH in the range of 8.0 to 11.0 and preferably in the range from 8.5 to 9.5.

11. The fluid of claim 5, which further comprises, in a minor amount, a freezing point depressant.

12. The fluid of claim 5, wherein the silicate is an inorganic alkali metal silicate.

13. The fluid of claim 12, wherein the inorganic alkali metal silicate is present in an amount below 1 wt %.

14. The fluid of claim 13, wherein the inorganic alkali metal silicate is present in the range from 0.001 to 0.5 wt %.

15. The fluid of claim 13, wherein the solvent is water.

16. The fluid of claim 15, wherein the freezing point depressant is a liquid alcohol or organic salt.

17. The fluid of claim 16, wherein the liquid alcohol is a poly alcohol.

18. The fluid of claim 16, wherein the organic salt is selected from the group consisting of formiate, acetate, proprionate, adipate, succinate, or combination thereof

19. The fluid of claim 5, which further comprises at least one coolant additive selected from the group consisting of silicates, nitrites, nitrates, phospites, molybdates, anti-oxidants, thiazole derivatives, triazole, polyacrylates, phosphonates and borates.

20. The process of conditioning a metal surface in order to prevent corrosion.
